(19) United States
(12) Patent Application Publication
(10) Pub. No.: US 2025/0384742 A1
(43) Pub. Date: Dec. 18, 2025

(54) METHODS AND SYSTEMS FOR CONDUCTING A SECONDARY ELECTRONIC GAME IN A GAMING VENUE

(71) Applicant: IGT, Las Vegas, NV (US)

(72) Inventors: Dwayne Nelson, Las Vegas, NV (US); Kevin Higgins, Reno, NV (US)

(21) Appl. No.: 18/745,544

(22) Filed: Jun. 17, 2024

(51) Int. Cl. G07F 17/32; G06Q 40/04; G06Q 50/34

(52) U.S. Cl. CPC G07F 17/3267; G06Q 40/04; G06Q 50/34; G07F 17/3244; G07F 17/3262

(57) ABSTRACT

Embodiments of the present disclosure are directed to conducting a secondary electronic game based on events occurring in a set of primary electronic games within a gaming venue. More specifically, embodiments of the present disclosure provide a secondary game on top of the casino experience by providing a “fake” or intermediary currency, cryptocurrency, or other fictional medium of exchange that is changing in value. The player can elect to take winnings in a casino game in the intermediate, fictional currency and then decide when to exchange back to a local, real currency. The timing of that decision can make the player win even more or even lose some of their original winnings. In one embodiment the exchange rate is affected by the buying and selling of this intermediate, fictional currency by other players.

### BACKGROUND

The present disclosure is generally directed to electronic gaming and more particularly to conducting a secondary electronic game based on events occurring in a set of primary electronic games within a gaming venue.

Operators of casinos or other gaming venues are continuously looking for ways to build excitement and engagement within the gaming venue. While primary games such as slots, video poker, keno, video blackjack, video roulette, and others are updated frequently to maintain attention and excitement, additional interactions with players and gaming opportunities for the players outside of these primary games can further increase player engagement.

### BRIEF SUMMARY

Embodiments of the present disclosure are directed to conducting a secondary electronic game based on events occurring in a set of primary electronic games within a gaming venue. According to one embodiment, a system can comprise a communication interface, a processor coupled with the communication interface, and a memory coupled with and readable by the processor. The memory can store therein a set of instructions which, when executed by the processor, causes the processor to receive, from each of a plurality of gaming systems of a gaming venue, via the communication interface, game event information for a set of primary electronic games conducted on the plurality of gaming systems, maintain a value in an electronic record indicating a rate of exchange to a local currency for the gaming venue, and conduct a secondary electronic game based on the rate of exchange to the local currency for the gaming venue, wherein the value in the electronic record indicating the rate of exchange to the local currency for the gaming venue is adjusted in the secondary electronic game based on the received game event information for the set of primary electronic games.

For example, the received game event information from the set of primary electronic games can indicate a win event in a primary electronic game in the set of primary electronic games and conducting the secondary electronic game based on the rate of exchange to the local currency for the gaming venue can comprise increasing the value in the electronic record indicating the rate of exchange to the local currency for the gaming venue. In such cases, increasing the value in the electronic record indicating the rate of exchange to the local currency for the gaming venue can comprise, for example, increasing the value in the electronic record indicating the rate of exchange to the local currency for the gaming venue linearly based on the win event. In another example, the received game event information from the set of primary electronic games can indicate a cash out event in a primary electronic game in the set of primary electronic games and conducting the secondary electronic game based on the rate of exchange to the local currency for the gaming venue can comprise decreasing the value in the electronic record indicating the rate of exchange to the local currency for the gaming venue. In such cases, decreasing the value in the electronic record indicating the rate of exchange to the local currency for the gaming venue can comprise, for example, decreasing the value in the electronic record indicating the rate of exchange to the local currency for the gaming venue linearly based on the cashout event.

In some cases, maintaining the value in the electronic record indicating the rate of exchange to the local currency for the gaming venue can comprise maintaining the value in the electronic record indicating the rate of exchange to the local currency for the gaming venue at or above a predetermined minimum value. Additionally, or alternatively, maintaining the value in the electronic record indicating the rate of exchange to the local currency for the gaming venue can comprise maintaining the value in the electronic record indicating the rate of exchange to the local currency for the gaming venue at or below a predetermined maximum value. For example, maintaining the value in the electronic record indicating the rate of exchange to the local currency for the gaming venue at or below a predetermined maximum value can comprise triggering a cash out event in the set of primary electronic games in response to the value in the electronic record indicating the rate of exchange to the local currency for the gaming venue being equal to the predetermined maximum value. In another example, maintaining the value in the electronic record indicating the rate of exchange to the local currency for the gaming venue at or below a predetermined maximum value can comprise pausing the secondary electronic game in response to the value in the electronic record indicating the rate of exchange to the local currency for the gaming venue being equal to the predetermined maximum value.

According to another embodiment, a gaming system can comprise a processor and a memory coupled with and readable by the processor. The memory can store therein a set of instructions which, when executed by the processor, causes the processor to execute a primary electronic game with a player, detect a win event in the primary electronic game, wherein the win event is associated with a payout amount in a local currency, and present to the player an option to participate in a secondary electronic game using the payout amount associated with the win event in the primary electronic game. The secondary electronic game can be conducted based on a current value of a variable exchange rate associated with the local currency. In response to receiving an input indicating acceptance of the option to participate in the secondary electronic game, the instructions can further cause the processor to increment a credit meter of the primary electronic game based on the payout amount in the local currency associated with the win event and the current value of the variable exchange rate associated with the local currency.

For example, the current value of the variable exchange rate associated with the local currency can be variable based on events occurring in electronic games being conducted on a plurality of gaming systems within a gaming venue. The events occurring in the electronic games being conducted on the plurality of gaming systems within the gaming venue can comprise, for example, win events and cashout events. The instructions can further cause the processor to monitor the current value of the variable exchange rate associated with the local currency and adjust the credit meter of the primary electronic game based on the current value of the variable exchange rate associated with the local currency. For example, the instructions can further cause the processor to detect a cashout event in the secondary game and in response to the detected cashout event, provide to the player a credit in the local currency based on the credit meter of the primary electronic game and the current value of the variable exchange rate associated with the local currency. In some cases, the instructions further cause the processor to detect a cashout event in the secondary game, present to the player an option to participate in a tertiary electronic game using a current amount of the credit meter, wherein the tertiary electronic game determines the variable exchange rate associated with the local currency and in response to receiving an input indicating acceptance of the option to participate in the tertiatry electronic game, conducting the tertiary electronic game and determining a payout amount in the local currency based on the current amount of credit meter and the variable exchange rate associated with the local currency determined by the tertiary game.

According to yet another embodiment, a method for conducting electronic games in a gaming venue can comprise receiving, from each of a plurality of gaming systems of a gaming venue, game event information for a set of primary electronic games conducted on the plurality of gaming systems, maintaining a value in an electronic record indicating a rate of exchange to a local currency for the gaming venue, and conducting a secondary electronic game based on the rate of exchange to the local currency for the gaming venue. The value in the electronic record indicating the rate of exchange to the local currency for the gaming venue can be adjusted in the secondary electronic game based on the received game event information for the set of primary electronic games.

For example, the received game event information from the set of primary electronic games can indicate a win event in a primary electronic game in the set of primary electronic games and conducting the secondary electronic game based on the rate of exchange to the local currency for the gaming venue can comprise increasing the value in the electronic record indicating the rate of exchange to the local currency for the gaming venue. In such cases, increasing the value in the electronic record indicating the rate of exchange to the local currency for the gaming venue can comprise increasing the value in the electronic record indicating the rate of exchange to the local currency for the gaming venue non-linearly based on the win event. In another example, the received game event information from the set of primary electronic games can indicate a cash out event in a primary electronic game in the set of primary electronic games and conducting the secondary electronic game based on the rate of exchange to the local currency for the gaming venue can comprise decreasing the value in the electronic record indicating the rate of exchange to the local currency for the gaming venue. In some cases, the secondary electronic game can comprise a crash game and the crash game can cause the current exchange to the local currency for the gaming venue to decrease upon the occurrence of an event within the secondary electronic game.

Additional features and advantages are described herein and will be apparent from the following Description and the figures.

### BRIEF DESCRIPTION OF THE SEVERAL VIEWS OF THE DRAWINGS

FIG. 1 is a block diagram illustrating an exemplary gaming venue environment in which embodiments of the present disclosure can be implemented.

FIG. 2 is a block diagram illustrating additional details of components of an exemplary gaming venue host system according to one embodiment of the present disclosure.

FIG. 3 is a block diagram illustrating additional details of components of an exemplary gaming system according to one embodiment of the present disclosure.

FIG. 4 is a flowchart illustrating an exemplary process for conducting a secondary electronic game based on events occurring in a set of primary electronic games within a gaming venue according to one embodiment of the present disclosure.

FIG. 5 is a flowchart illustrating additional details of an exemplary process for conducting a secondary electronic game according to one embodiment of the present disclosure.

FIG. 6 is a flowchart illustrating additional details of an exemplary process for maintaining a value of a rate of exchange according to one embodiment of the present disclosure.

FIG. 7 is a flowchart illustrating an exemplary process for conducting a secondary electronic game based on events occurring in a set of primary electronic games within a gaming venue according to another embodiment of the present disclosure.

FIG. 8 is a flowchart illustrating an exemplary process for conducting a secondary electronic game based on events occurring in a set of primary electronic games within a gaming venue according to yet another embodiment of the present disclosure.

### DETAILED DESCRIPTION

Embodiments of the present disclosure are directed to conducting a secondary electronic game based on events occurring in a set of primary electronic games within a gaming venue. More specifically, embodiments of the present disclosure provide a secondary game on top of the casino experience by providing a “fake” or intermediary currency, cryptocurrency, or other fictional medium of exchange that is changing in value. The player can elect to take winnings in a casino game in the intermediate, fictional currency and then decide when to exchange back to a local, real currency. The timing of that decision can make the player win even more or even lose some of their original winnings. In one embodiment the exchange rate is affected by the buying and selling of this intermediate, fictional currency by other players. In one embodiment, the exchanging back to real currency can be through a separate game to determine the exchange rate.

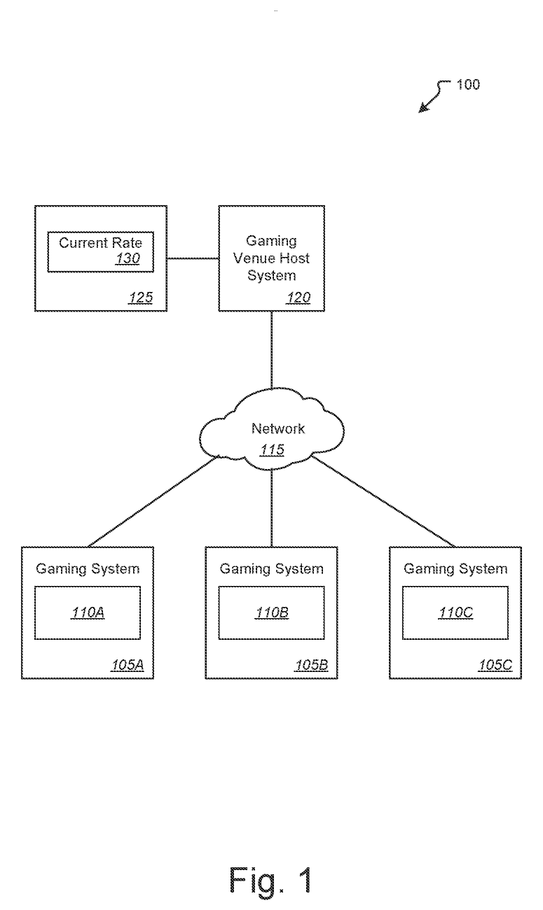

FIG. 1 is a block diagram illustrating an exemplary gaming venue environment in which embodiments of the present disclosure can be implemented. As illustrated in this example, the environment 100 can comprise a plurality of gaming systems 105A-105C. Generally speaking, the gaming systems 105A-105C can each comprise any Electronic Gaming Machine (EGM), kiosk, or similar gaming system as may be found in a casino or other gaming venue. Each gaming system 105A-105C can execute any of a variety of primary electronic games including, but not limited to slots, video slots, video poker, keno, etc. to be played by a player and presented to the player through a display device 110A-110C of the gaming system 105A-105C.

Each gaming system 105A-105C can be coupled with a communication network 115. The communication network 115 can comprise any one or more wired and/or wireless, local-area and/or wide-area networks as known in the art including, but not limited to, the Internet. The environment 100 can further comprise a gaming venue host system 120 also coupled with the communication network 115. The gaming venue system 120 can comprise any one or more servers and/or other computing devices such as commonly used to manage gaming systems 105A-105C and other systems in a casino or other gaming venue.

Embodiments of the present disclosure are directed to providing a secondary electronic game in addition to the primary electronic games being played on the gaming systems 105A-105C. The gaming venue host system 120 can conduct this secondary game based on a “fake” cryptocurrency, fantasy currency, or other imaginary or virtual means of exchange. Such means of exchange is fake, imaginary, or virtual in the sense that there is no real cryptocurrency or other intermediate currency. According to one embodiment, when players win in a primary game on a gaming system 105A, they can be given an option to choose to win in the cryptocurrency, fantasy currency, or other imaginary or virtual means of exchange and thus each win buys the cryptocurrency, fantasy currency, or other imaginary or virtual means of exchange and can drive up the price or exchange rate to real currency. This allows players to win on top of winning, e.g., they win the slot game and then make money on the cryptocurrency, fantasy currency, or other imaginary or virtual means of exchange. However, when players cash out, they sell the cryptocurrency, fantasy currency, or other imaginary or virtual means of exchange which can move the price down or exchange rate to real currency. Thus, embodiments described herein add another layer of gambling on top of the gambling in the primary electronic games played on the gaming systems 105A-105C because the cryptocurrency, fantasy currency, or other imaginary or virtual means of exchange value will fluctuate over time. This also adds excitement when the casino floor is busy because the cryptocurrency, fantasy currency, or other imaginary or virtual means of exchange can spike in value as players are winning and therefore buying cryptocurrency, fantasy currency, or other imaginary or virtual means of exchange.

In one embodiment, a cryptocurrency, fantasy currency, or other imaginary or virtual means of exchange purchase event can happen causing the player to purchase cryptocurrency at the current exchange rate. Then, a cryptocurrency, fantasy currency, or other imaginary or virtual means of exchange sell event can happen causing the system to convert some or all of the player’s cryptocurrency, fantasy currency, or other imaginary or virtual means of exchange to a local, real currency, e.g., dollars. For example, a primary game can be conducted where the player opts into the secondary game feature. When the player wins the primary game, e.g., a slots game, the gaming system 105 can automatically take the win, e.g., in dollars, and convert it to cryptocurrency, fantasy currency, or other imaginary or virtual means of exchange based on a current rate of exchange maintained by the gaming venue host system 120. The gaming system 105A can display the cryptocurrency balance to the player through the display device 110A of the gaming system 105A. When the player cashes out, the gaming system 105A can convert the cryptocurrency, fantasy currency, or other imaginary or virtual means of exchange to dollars or other local, real currency and perform the cashout such as, for example, printing a Ticket-In, Ticket-Out (TITO) ticket.

In one embodiment, the total amount of money in the virtual monetary system can remain the same such that the total amount of money exchanged for cryptocurrency, fantasy currency, or other imaginary or virtual means of exchange equals the total amount of money exchanged out of cryptocurrency, fantasy currency, or other imaginary or virtual means of exchange. However, in other embodiments the gaming venue host system 120 or gaming system 105A can charge a fee for the exchange such that the gaming venue retains a percentage such as 1%.

In one embodiment, the gaming venue host system 120 can have a fixed amount of cryptocurrency, fantasy currency, or other imaginary or virtual means of exchange. The gaming venue host system 120 can have a starting exchange rate and/or minimum exchange rate. This could be one, for example, such that each dollar or other increment of local, real currency receives one cryptocurrency, fantasy currency, or other imaginary or virtual means of exchange unit. With each win, the player can receive cryptocurrency, fantasy currency, or other imaginary or virtual means of exchange and the exchange rate changes based on the amount of remaining cryptocurrency, fantasy currency, or other imaginary or virtual means of exchange. In this manner, winning and exchanging the cryptocurrency, fantasy currency, or other imaginary or virtual means of exchange makes it more and more valuable, i.e., the price increases. When a player cashes out, the player is awarded dollars at the current exchange rate for the cryptocurrency, fantasy currency, or other imaginary or virtual means of exchange, and the exchange rate can be updated.

In one embodiment, when the gaming venue host system 120 runs out of cryptocurrency, fantasy currency, or other imaginary or virtual means of exchange, no more cryptocurrency, fantasy currency, or other imaginary or virtual means of exchange can be purchased and cryptocurrency, fantasy currency, or other imaginary or virtual means of exchange can only sold. In another embodiment, when the gaming venue host system 120 runs out of cryptocurrency, fantasy currency, or other imaginary or virtual means of exchange, the gaming venue host system 120 can trigger cash outs of players. This could be based on a first in/first out, or ranked by another algorithm which takes into account one or more of how long each player is playing, how much each player has won, things (categories) the players have won, randomness, player loyalty account status, player points, and/or other factors. For example, when the gaming venue host system 120 runs out of or runs low on cryptocurrency, fantasy currency, or other imaginary or virtual means of exchange, the cashout can be triggered. The gaming venue host system 120 can then rank the players on the amount won over the past hours and cash out the players in that order, i.e., highest to lowest win amounts.

In another embodiment, the cryptocurrency, fantasy currency, or other imaginary or virtual means of exchange can be infinite. In one such implementation, the total exchanged into cryptocurrency, fantasy currency, or other imaginary or virtual means of exchange can equal the total exchanged out. Other models may change the exchange rate based on one or more of: amount of the win, i.e., amount of the cryptocurrency, fantasy currency, or other imaginary or virtual means of exchange purchase, amount of the cash out, i.e., amount of the cryptocurrency, fantasy currency, or other imaginary or virtual means of exchange sale, win categories, such that certain wins change the exchange rate differently. player loyalty account status, randomness, progressives, time, manual input of the operator of the gaming venue, and/or others.

For example, the system might be configured to increase the exchange rate by 1% after a progressive win. In another example, the operator can increase the exchange rate during a certain time period such as Friday nights. When the exchange rate is adjusted in this manner, the operator can end up funding the crypto exchange to some extent. This allows the operator to run a promotion that effectively can be funded via this exchange of cryptocurrency, fantasy currency, or other imaginary or virtual means of exchange.

In one embodiment, the player can be presented the current cryptocurrency, fantasy currency, or other imaginary or virtual means of exchange balance on the game screen on the display device 110A of the gaming system 105A. Additionally, or alternatively, a current exchange rate for the cryptocurrency, fantasy currency, or other imaginary or virtual means of exchange can be presented on one or more display devices 125 at various locations in the gaming venue, perhaps in the form of a ticker, graph, etc.

In one embodiment, the gaming venue host system 120 can limit when the player can cash out. For example, the gaming venue host system 120 might limit the player to three cash outs per hour or to only cash out after a certain amount of play measure in monetary amount or time.

In some embodiments, the gaming venue host system 120 might purchase or sell cryptocurrency, fantasy currency, or other imaginary or virtual means of exchange to influence the price. For example, the operator of the gaming venue might instruct the gaming venue host system 120 to purchase cryptocurrency, fantasy currency, or other imaginary or virtual means of exchange on a Friday night to drive up the price. This would likely result in the operator losing money and therefore would be used for promotions and advertising.

The exchange rate, thus far, has been described as a linear function such that the rate changed linearly with the amount exchanged. According to another embodiment, the exchange rate can be determined by an exponential function, such as the multiplier function used in crash games. With this exponential change in exchange rate, the more money exchanged into cryptocurrency, fantasy currency, or other imaginary or virtual means of exchange, the faster the value of the increases. This could lead to large wins and losses in the cryptocurrency, fantasy currency, or other imaginary or virtual means of exchange exchanging. Imagine that the value of the cryptocurrency, fantasy currency, or other imaginary or virtual means of exchange starts at $1.00 and increases to $2, then $4 and then $8. If a player that has won $100 when the exchange rate was $2.00 could quadruple their winnings when the cryptocurrency, fantasy currency, or other imaginary or virtual means of exchange reached $8 and therefore they would likely want to cash out to capitalize on the new rate. But the exchange rate could increase more, so the excitement could produce a fun game on top of the slot experience.

In an alternative embodiment, the cashless wagering account of a casino or other gaming venue could have its own currency that is market-based or gamified properties. On cashout from gaming system, if the player has established an account in the casino’s electronic wallet system, or cashless wagering system, then funds can be transferred off the gaming system into their corresponding account. Upon the transfer into that account, funds could be converted from the base currency of the gaming venue to the cryptocurrency, fantasy currency, or other imaginary or virtual means of exchange of the cashless wagering system. This conversion rate could be floating or adjusted based upon some of the mechanisms discussed herein. In one embodiment, balances in the player’s cashless wagering account could be 100% in this alternative currency. Alternatively, they could be partially in this alternative currency, or only upon player request, such as when the player feels like they are lucky or they like the patterns they’re seeing in the swings of the cryptocurrency, fantasy currency, or other imaginary or virtual means of exchange. When a player then makes a transfer out of their wallet, for funds held in this alternative currency, then those funds being transferred can automatically be converted into the local, real currency for the location of the casino at the current exchange rate.

Another embodiment would allow players to win the cryptocurrency, fantasy currency, or other imaginary or virtual means of exchange as some fixed exchange rate, such as 1:1. Then, when the player wants to convert from the cryptocurrency, fantasy currency, or other imaginary or virtual means of exchange back to real currency, a separate game can be played to determine the exchange rate back. For example, a wheel could be spun with exchange rates of 0.7, 0.8, …, 1.0, …, 1.3 on it. The player can spin the wheel to determine the exchange rate.

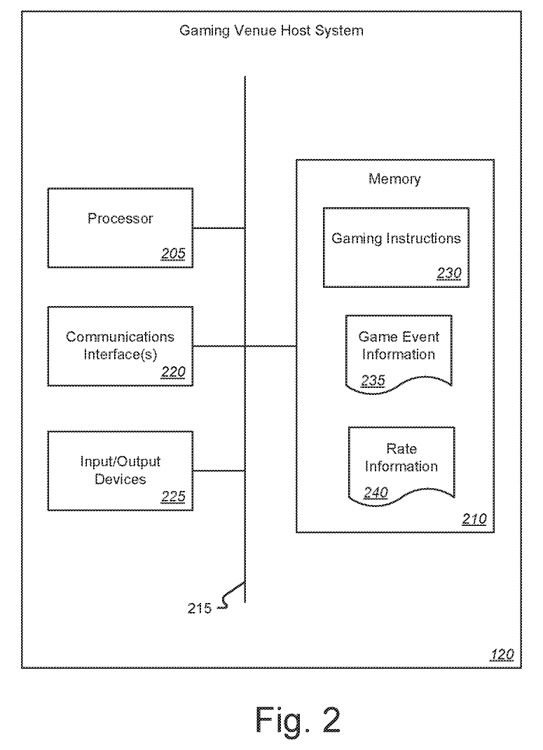

FIG. 2 is a block diagram illustrating additional details of components of an exemplary gaming venue host system according to one embodiment of the present disclosure. As illustrated in this example, a gaming venue host system 120 such as described above can comprise a processor 205. The processor 205 may correspond to one or many computer processing devices. For instance, the processor 205 may be provided as silicon, as a Field Programmable Gate Array (FPGA), an Application-Specific Integrated Circuit (ASIC), any other type of Integrated Circuit (IC) chip, a collection of IC chips, or the like. As a more specific example, the processor 205 may be provided as a microprocessor, Central Processing Unit (CPU), or plurality of microprocessors that are configured to execute the instructions sets stored in a memory 210. Upon executing the instruction sets stored in memory 210, the processor 205 enables various functions of the gaming venue host system 120 as described herein.

The memory 210 can be coupled with and readable by the processor 205 via a communications bus 215. The memory 210 may include any type of computer memory device or collection of computer memory devices. Non-limiting examples of memory 210 include Random Access Memory (RAM), Read Only Memory (ROM), flash memory, Electronically-Erasable Programmable ROM (EEPROM), Dynamic RAM (DRAM), etc. The memory 210 may be configured to store the instruction sets depicted in addition to temporarily storing data for the processor 205 to execute various types of routines or functions.

The processor 205 can also be coupled with one or more communication interface(s) 220 and one or more input/output devices 225 via the communications bus 215. The communication interface(s) 220 can comprise, for example, an Ethernet, Bluetooth, WiFi, cellular, and/or other type of wired and/or wireless communications interface. Via the communication interface(s) 220, the gaming venue host system 120 can communicate with other devices and/or systems through a communications network 115 as described above. The input/output devices 225 can include, but are not limited to a display device 125 such as a Liquid Crystal Display (LCD), Light Emitting Diode (LED), Organic Light Emitting Diode (OLED), or other type of display, a ticket printer, etc.

The memory 210 can store therein a set of gaming instructions 230 which, when executed by the processor 205, cause the processor 205 to conducting a secondary electronic game based on events occurring in a set of primary electronic games within a gaming venue. More specifically, the gaming instructions 230, when executed by the processor 205, can cause the processor 205 to receive, from each of a plurality of gaming systems 105A-105C of a gaming venue, via the communication interface 220, game event information 235 for a set of primary electronic games conducted on the plurality of gaming systems 105A-105C, maintain a value in an electronic record 240 indicating a rate of exchange to a local currency for the gaming venue, and conduct a secondary electronic game based on the rate of exchange to the local currency for the gaming venue, wherein the value in the electronic record 240 indicating the rate of exchange to the local currency for the gaming venue is adjusted in the secondary electronic game based on the received game event information for the set of primary electronic games.

For example, the received game event information from the set of primary electronic games can indicate a win event in a primary electronic game in the set of primary electronic games and conducting the secondary electronic game based on the rate of exchange to the local currency for the gaming venue can comprise increasing the value in the electronic record indicating the rate of exchange to the local currency for the gaming venue. In such cases, increasing the value in the electronic record indicating the rate of exchange to the local currency for the gaming venue can comprise, for example, increasing the value in the electronic record indicating the rate of exchange to the local currency for the gaming venue linearly based on the win event. In another example, the received game event information from the set of primary electronic games can indicate a cash out event in a primary electronic game in the set of primary electronic games and conducting the secondary electronic game based on the rate of exchange to the local currency for the gaming venue can comprise decreasing the value in the electronic record indicating the rate of exchange to the local currency for the gaming venue. In such cases, decreasing the value in the electronic record indicating the rate of exchange to the local currency for the gaming venue can comprise, for example, decreasing the value in the electronic record indicating the rate of exchange to the local currency for the gaming venue linearly based on the cashout event.

In some cases, maintaining the value in the electronic record indicating the rate of exchange to the local currency for the gaming venue can comprise maintaining the value in the electronic record indicating the rate of exchange to the local currency for the gaming venue at or above a predetermined minimum value. Additionally, or alternatively, maintaining the value in the electronic record indicating the rate of exchange to the local currency for the gaming venue can comprise maintaining the value in the electronic record indicating the rate of exchange to the local currency for the gaming venue at or below a predetermined maximum value. For example, maintaining the value in the electronic record indicating the rate of exchange to the local currency for the gaming venue at or below a predetermined maximum value can comprise triggering a cash out event in the set of primary electronic games in response to the value in the electronic record indicating the rate of exchange to the local currency for the gaming venue being equal to the predetermined maximum value. In another example, maintaining the value in the electronic record indicating the rate of exchange to the local currency for the gaming venue at or below a predetermined maximum value can comprise pausing the secondary electronic game in response to the value in the electronic record indicating the rate of exchange to the local currency for the gaming venue being equal to the predetermined maximum value.

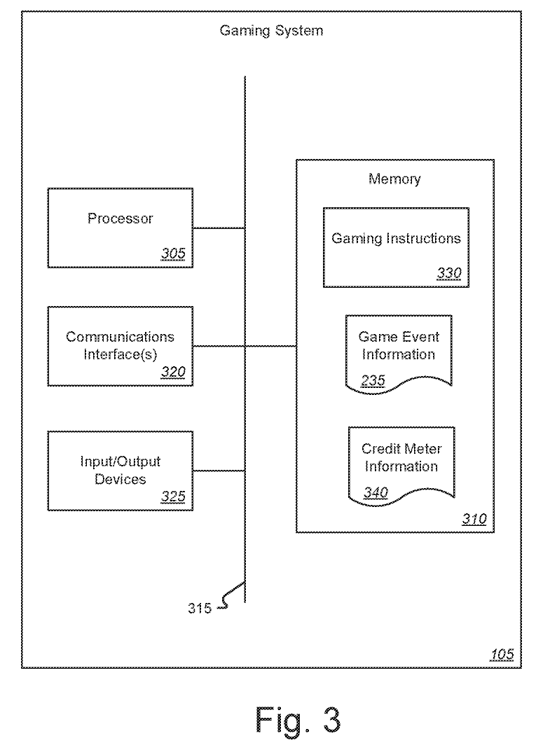

FIG. 3 is a block diagram illustrating additional details of components of an exemplary gaming system according to one embodiment of the present disclosure. As illustrated in this example, a gaming system 105 can comprise a processor 305 such as any of the various types of processors described above. A memory 310 can be coupled with and readable by the processor 305 via a communications bus 315. The memory 310 can comprise any one or more of the different types of volatile and/or non-volatile memories described above. The processor 305 can also be coupled with one or more communication interfaces 320 and one or more input/output devices 325. The communication interfaces 320 can comprise, for example, an Ethernet, Bluetooth, WiFi, cellular, and/or other type of wired and/or wireless communications interface. The input/output devices 325 can include, but are not limited to a display device 110 such as a LCD, LED, OLED, or other type of display, a ticket printer, etc.

The memory 310 can store therein a set of gaming instructions 330 which, when executed by the processor 305, cause the processor 305 to execute a primary electronic game with a player, detect a win event in the primary electronic game, wherein the win event is associated with a payout amount in a local currency, and present to the player an option to participate in a secondary electronic game using the payout amount associated with the win event in the primary electronic game. The secondary electronic game can be conducted based on a current value of a variable exchange rate associated with the local currency. In response to receiving an input indicating acceptance of the option to participate in the secondary electronic game, the gaming instructions 330 can further cause the processor 305 to increment a credit meter 340 of the primary electronic game based on the payout amount in the local currency associated with the win event and the current value of the variable exchange rate associated with the local currency.

For example, the current value of the variable exchange rate associated with the local currency can be variable based on events occurring in electronic games being conducted on a plurality of gaming systems 102A-105C within a gaming venue. The events occurring in the electronic games being conducted on the plurality of gaming systems 105A-105C within the gaming venue can comprise, for example, win events and cashout events. The gaming instructions 330 can further cause the processor 305 to monitor the current value of the variable exchange rate associated with the local currency and adjust the credit meter 340 of the primary electronic game based on the current value of the variable exchange rate associated with the local currency. For example, the gaming instructions 330 can further cause the processor 305 to detect a cashout event in the secondary game and in response to the detected cashout event, provide to the player a credit in the local currency based on the credit meter of the primary electronic game and the current value of the variable exchange rate associated with the local currency. In some cases, the gaming instructions 330 further cause the processor 305 to detect a cashout event in the secondary game, present to the player an option to participate in a tertiary electronic game using a current amount of the credit meter 340, wherein the tertiary electronic game determines the variable exchange rate associated with the local currency and in response to receiving an input indicating acceptance of the option to participate in the tertiary electronic game, conducting the tertiary electronic game and determining a payout amount in the local currency based on the current amount of credit meter and the variable exchange rate associated with the local currency determined by the tertiary game.

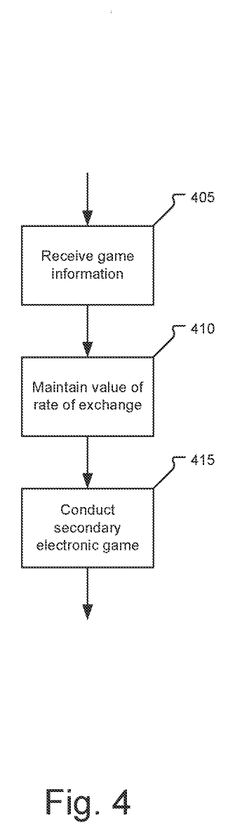

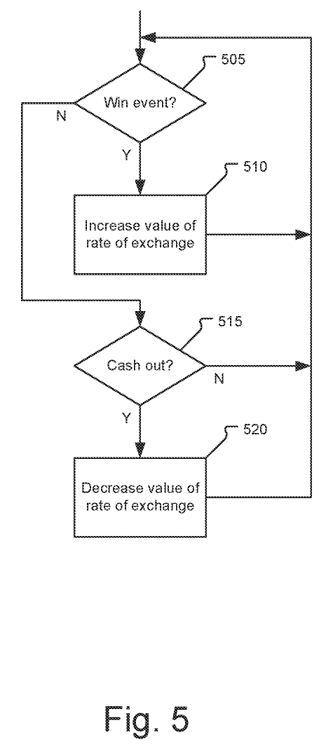

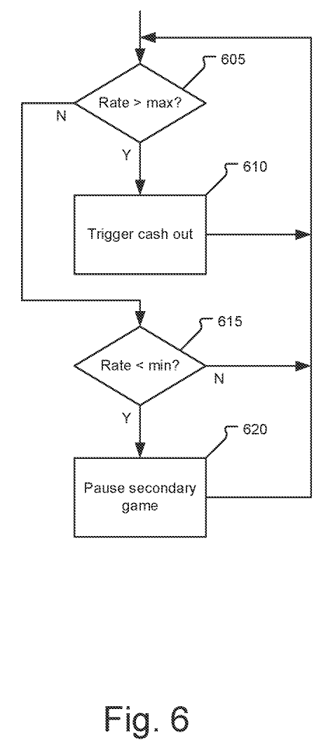

FIG. 4 is a flowchart illustrating an exemplary process for conducting a secondary electronic game based on events occurring in a set of primary electronic games within a gaming venue according to one embodiment of the present disclosure. As illustrated in this example, conducting a secondary electronic game based on events occurring in a set of primary electronic games can comprise receiving 405, from each of a plurality of gaming systems 105A-105C of a gaming venue, game event information for a set of primary electronic games conducted on the plurality of gaming systems 105A-105C, maintaining 410 a value in an electronic record indicating a rate of exchange to a local currency for the gaming venue, and conducting 415 a secondary electronic game based on the rate of exchange to the local currency for the gaming venue. As noted above, the value in the electronic record indicating the rate of exchange to the local currency for the gaming venue can be adjusted in the secondary electronic game based on the received game event information for the set of primary electronic games. Additional details of an exemplary process for conducting a secondary electronic game will be described below with reference to FIG. 5 while additional details of an exemplary process for maintaining a value of a rate of exchange will be described below with reference to FIG. 6.

FIG. 5 is a flowchart illustrating additional details of an exemplary process for conducting a secondary electronic game according to one embodiment of the present disclosure. As noted above, the received game event information from the set of primary electronic games can indicate a win event or a cash out in a primary electronic game in the set of primary electronic games. Accordingly, a determination 505 can be made as to whether the received game event information indicates the occurrence of a win event. In response to determining 505 the received game event information indicates the occurrence of a win event, the value in the electronic record indicating the rate of exchange to the local currency for the gaming venue can be increased 510. In such cases, increasing 510 the value in the electronic record indicating the rate of exchange to the local currency for the gaming venue can comprise, for example, increasing the value in the electronic record indicating the rate of exchange to the local currency for the gaming venue linearly or non-linearly based on the win event.

In response to determining 515 the received game event information does not indicate the occurrence of a win event, a further determination can be made as to whether the received game event information indicates the occurrence of a cash out event. In response to determining 515 the received game event information indicates the occurrence of a cash out event, the value in the electronic record indicating the rate of exchange to the local currency for the gaming venue can be decreased 520. In such cases, decreasing 520 the value in the electronic record indicating the rate of exchange to the local currency for the gaming venue can comprise, for example, decreasing the value in the electronic record indicating the rate of exchange to the local currency for the gaming venue linearly based on the cashout event.

FIG. 6 is a flowchart illustrating additional details of an exemplary process for maintaining a value of a rate of exchange according to one embodiment of the present disclosure. As noted above, maintaining the value in the electronic record indicating the rate of exchange to the local currency for the gaming venue can comprise maintaining the value in the electronic record indicating the rate of exchange to the local currency for the gaming venue at or above a predetermined minimum value and or below a predetermined maximum value. According, a determination 605 can be made as to whether the current rate of exchange to the local currency for the gaming venue is greater than, or equal too, the predetermined maximum value. In response to determining 605 the current rate of exchange to the local currency for the gaming venue is greater than, or equal too, the predetermined maximum value, a cash out event can be triggered 610.

In response to determining 605 the current rate of exchange to the local currency for the gaming venue is not greater than, or equal too, the predetermined maximum value, a further determination 615 can be made as to whether the current rate of exchange to the local currency for the gaming venue is less than, or equal too, the predetermined minimum value. In response to determining 615 the current rate of exchange to the local currency for the gaming venue is less than, or equal too, the predetermined minimum value, the secondary electronic game can be paused 620, e.g., until further win events and/or purchases occur to increase the value for the rate of exchange to the local currency for the gaming venue.

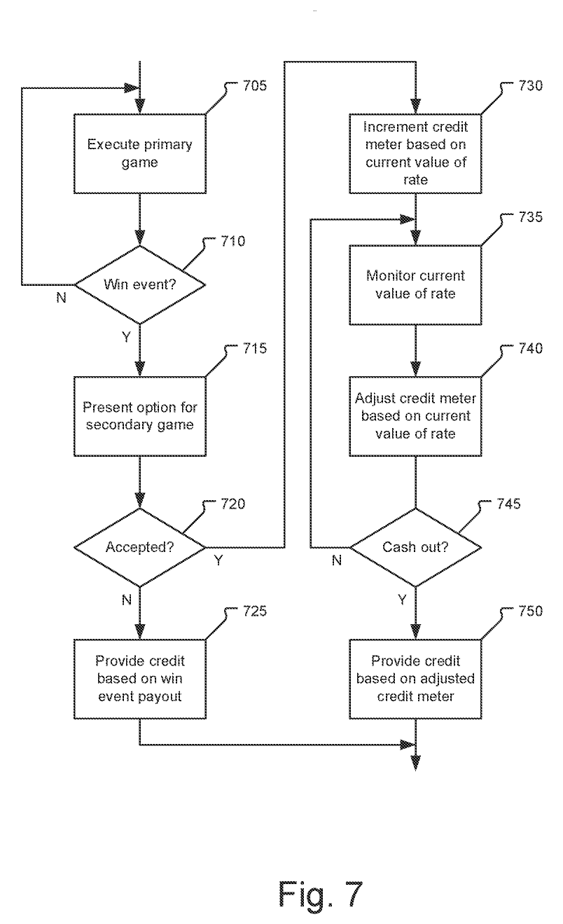

FIG. 7 is a flowchart illustrating an exemplary process for conducting a secondary electronic game based on events occurring in a set of primary electronic games within a gaming venue according to another embodiment of the present disclosure. As illustrated in this example, conducting a secondary electronic game based on events occurring in a set of primary electronic games within a gaming venue can comprise executing 705 a primary electronic game with a player and determining 710 whether a win event has been detected in the primary electronic game. The win event can be associated with a payout amount in a local currency. An option to participate in a secondary electronic game using the payout amount associated with the win event in the primary electronic game can be presented 715 to the player. The secondary electronic game can be conducted based on a current value of a variable exchange rate associated with the local currency.

A determination 720 can be made as to whether the option to participate in a secondary electronic game using the payout amount associated with the win event in the primary electronic game has been accepted. In response to determining 720 the option to participate in the secondary electronic game has not been accepted, credit for the win amount can be provided based on the payout amount for the win event as usual.

In response to determining 720 the option to participate in the secondary electronic game has been accepted, a credit meter of the primary electronic game can be incremented 725 based on the payout amount in the local currency associated with the win event and the current value of the variable exchange rate associated with the local currency.

While the player remains in the secondary game, the current value of the variable exchange rate associated with the local currency can be monitored 735 and the credit meter of the primary electronic game can be adjusted 740 based on the current value of the variable exchange rate associated with the local currency. A determination 745 can be made as to whether a cash out has occurred in the secondary electronic game has occurred. In response to determining 745 a cash out has occurred in the secondary electronic game has occurred, the player can be provided 750 a credit in the local currency based on the credit meter of the primary electronic game and the current value of the variable exchange rate associated with the local currency.

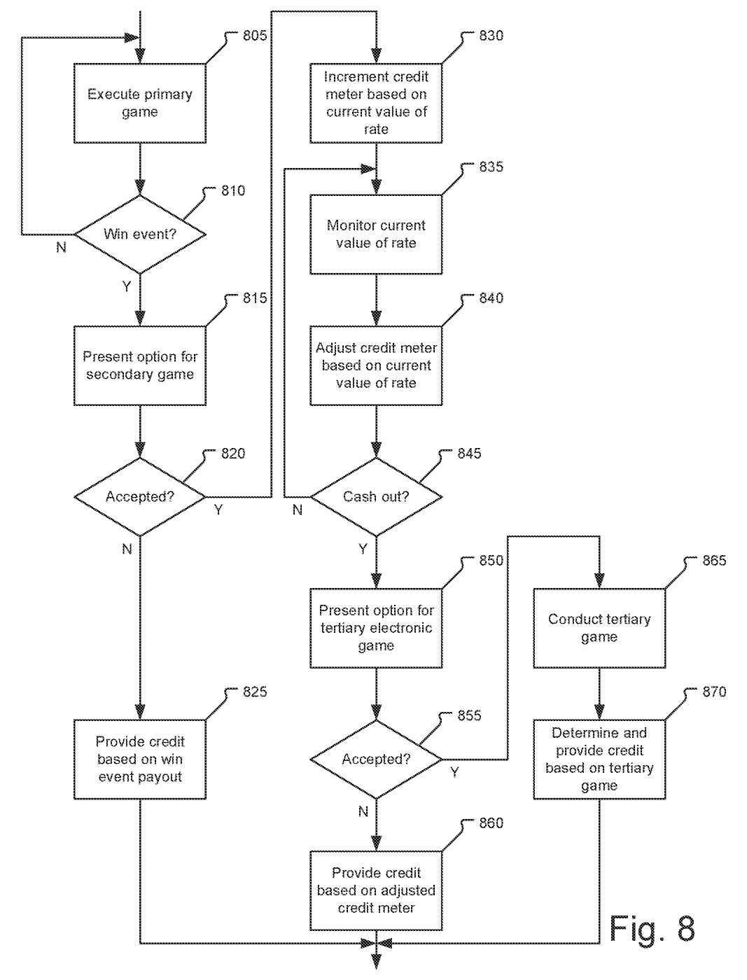

FIG. 8 is a flowchart illustrating an exemplary process for conducting a secondary electronic game based on events occurring in a set of primary electronic games within a gaming venue according to yet another embodiment of the present disclosure.

As illustrated in this example, conducting a secondary electronic game based on events occurring in a set of primary electronic games within a gaming venue can comprise executing 805 a primary electronic game with a player and determining 810 whether a win event has been detected in the primary electronic game. The win event can be associated with a payout amount in a local currency. An option to participate in a secondary electronic game using the payout amount associated with the win event in the primary electronic game can be presented 815 to the player. The secondary electronic game can be conducted based on a current value of a variable exchange rate associated with the local currency.

A determination 820 can be made as to whether the option to participate in a secondary electronic game using the payout amount associated with the win event in the primary electronic game has been accepted. In response to determining 820 the option to participate in the secondary electronic game has not been accepted, credit for the win amount can be provided based on the payout amount for the win event as usual.

In response to determining 820 the option to participate in the secondary electronic game has been accepted, a credit meter of the primary electronic game can be incremented 825 based on the payout amount in the local currency associated with the win event and the current value of the variable exchange rate associated with the local currency.

While the player remains in the secondary game, the current value of the variable exchange rate associated with the local currency can be monitored 835 and the credit meter of the primary electronic game can be adjusted 840 based on the current value of the variable exchange rate associated with the local currency. A determination 845 can be made as to whether a cash out has occurred in the secondary electronic game has occurred. In response to determining 845 a cash out has occurred in the secondary electronic game has occurred, an option can be presented 850 to the player to participate in a tertiary electronic game to determine the cash out amount and a determination 855 can be made as to whether the player has accepted the option. In response to determining 855 the player has not accepted the option to participate in a tertiary electronic game, the player can be provided 860 a credit in the local currency based on the credit meter of the primary electronic game and the current value of the variable exchange rate associated with the local currency.

In response to determining 855 the player has accepted the option to participate in a tertiary electronic game, the tertiary electronic game can be conducted 865 and a payout amount in the local currency can be determined and provided 870 based on the current amount of credit meter and the variable exchange rate associated with the local currency determined by the tertiary game, wherein a result of the tertiary electronic game determines the variable exchange rate associated with the local currency.

A number of variations and modifications of the disclosure can be used. It would be possible to provide for some features of the disclosure without providing others.

The present disclosure contemplates a variety of different gaming systems each having one or more of a plurality of different features, attributes, or characteristics. A “gaming system” as used herein refers to various configurations of: (a) one or more central servers, central controllers, or remote hosts; (b) one or more electronic gaming machines such as those located on a casino floor; and/or (c) one or more personal gaming devices, such as desktop computers, laptop computers, tablet computers or computing devices, personal digital assistants, mobile phones, and other mobile computing devices. Moreover, an EGM as used herein refers to any suitable electronic gaming machine which enables a player to play a game (including but not limited to a game of chance, a game of skill, and/or a game of partial skill) to potentially win one or more awards, wherein the EGM comprises, but is not limited to: a slot machine, a video poker machine, a video lottery terminal, a terminal associated with an electronic table game, a video keno machine, a video bingo machine located on a casino floor, a sports betting terminal, or a kiosk, such as a sports betting kiosk.

In various embodiments, the gaming system of the present disclosure includes: (a) one or more electronic gaming machines in combination with one or more central servers, central controllers, or remote hosts; (b) one or more personal gaming devices in combination with one or more central servers, central controllers, or remote hosts; (c) one or more personal gaming devices in combination with one or more electronic gaming machines; (d) one or more personal gaming devices, one or more electronic gaming machines, and one or more central servers, central controllers, or remote hosts in combination with one another; (e) a single electronic gaming machine; (f) a plurality of electronic gaming machines in combination with one another; (g) a single personal gaming device; (h) a plurality of personal gaming devices in combination with one another; (i) a single central server, central controller, or remote host; and/or (j) a plurality of central servers, central controllers, or remote hosts in combination with one another.

For brevity and clarity and unless specifically stated otherwise, “EGM” as used herein represents one EGM or a plurality of EGMs, “personal gaming device” as used herein represents one personal gaming device or a plurality of personal gaming devices, and “central server, central controller, or remote host” as used herein represents one central server, central controller, or remote host or a plurality of central servers, central controllers, or remote hosts.

As noted above, in various embodiments, the gaming system includes an EGM (or personal gaming device) in combination with a central server, central controller, or remote host. In such embodiments, the EGM (or personal gaming device) is configured to communicate with the central server, central controller, or remote host through a data network or remote communication link. In certain such embodiments, the EGM (or personal gaming device) is configured to communicate with another EGM (or personal gaming device) through the same data network or remote communication link or through a different data network or remote communication link. For example, the gaming system includes a plurality of EGMs that are each configured to communicate with a central server, central controller, or remote host through a data network.

In certain embodiments in which the gaming system includes an EGM (or personal gaming device) in combination with a central server, central controller, or remote host, the central server, central controller, or remote host is any suitable computing device (such as a server) that includes at least one processor and at least one memory device or data storage device. As further described herein, the EGM (or personal gaming device) includes at least one EGM (or personal gaming device) processor configured to transmit and receive data or signals representing events, messages, commands, or any other suitable information between the EGM (or personal gaming device) and the central server, central controller, or remote host. The at least one processor of that EGM (or personal gaming device) is configured to execute the events, messages, or commands represented by such data or signals in conjunction with the operation of the EGM (or personal gaming device). Moreover, the at least one processor of the central server, central controller, or remote host is configured to transmit and receive data or signals representing events, messages, commands, or any other suitable information between the central server, central controller, or remote host and the EGM (or personal gaming device). The at least one processor of the central server, central controller, or remote host is configured to execute the events, messages, or commands represented by such data or signals in conjunction with the operation of the central server, central controller, or remote host. One, more than one, or each of the functions of the central server, central controller, or remote host may be performed by the at least one processor of the EGM (or personal gaming device). Further, one, more than one, or each of the functions of the at least one processor of the EGM (or personal gaming device) may be performed by the at least one processor of the central server, central controller, or remote host.

In certain such embodiments, computerized instructions for controlling any games (such as any primary or base games and/or any secondary or bonus games) displayed by the EGM (or personal gaming device) are executed by the central server, central controller, or remote host. In such “thin client” embodiments, the central server, central controller, or remote host remotely controls any games (or other suitable interfaces) displayed by the EGM (or personal gaming device), and the EGM (or personal gaming device) is utilized to display such games (or suitable interfaces) and to receive one or more inputs or commands. In other such embodiments, computerized instructions for controlling any games displayed by the EGM (or personal gaming device) are communicated from the central server, central controller, or remote host to the EGM (or personal gaming device) and are stored in at least one memory device of the EGM (or personal gaming device). In such “thick client” embodiments, the at least one processor of the EGM (or personal gaming device) executes the computerized instructions to control any games (or other suitable interfaces) displayed by the EGM (or personal gaming device).

In various embodiments in which the gaming system includes a plurality of EGMs (or personal gaming devices), one or more of the EGMs (or personal gaming devices) are thin client EGMs (or personal gaming devices) and one or more of the EGMs (or personal gaming devices) are thick client EGMs (or personal gaming devices). In other embodiments in which the gaming system includes one or more EGMs (or personal gaming devices), certain functions of one or more of the EGMs (or personal gaming devices) are implemented in a thin client environment, and certain other functions of one or more of the EGMs (or personal gaming devices) are implemented in a thick client environment. In one such embodiment in which the gaming system includes an EGM (or personal gaming device) and a central server, central controller, or remote host, computerized instructions for controlling any primary or base games displayed by the EGM (or personal gaming device) are communicated from the central server, central controller, or remote host to the EGM (or personal gaming device) in a thick client configuration, and computerized instructions for controlling any secondary or bonus games or other functions displayed by the EGM (or personal gaming device) are executed by the central server, central controller, or remote host in a thin client configuration.

In certain embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a local area network (LAN) in which the EGMs (or personal gaming devices) are located substantially proximate to one another and/or the central server, central controller, or remote host. In one example, the EGMs (or personal gaming devices) and the central server, central controller, or remote host are located in a gaming establishment or a portion of a gaming establishment.

In other embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include a wide area network (WAN) in which one or more of the EGMs (or personal gaming devices) are not necessarily located substantially proximate to another one of the EGMs (or personal gaming devices) and/or the central server, central controller, or remote host. For example, one or more of the EGMs (or personal gaming devices) are located: (a) in an area of a gaming establishment different from an area of the gaming establishment in which the central server, central controller, or remote host is located; or (b) in a gaming establishment different from the gaming establishment in which the central server, central controller, or remote host is located. In another example, the central server, central controller, or remote host is not located within a gaming establishment in which the EGMs (or personal gaming devices) are located. In certain embodiments in which the communication network includes a WAN, the gaming system includes a central server, central controller, or remote host and an EGM (or personal gaming device) each located in a different gaming establishment in a same geographic area, such as a same city or a same state. Gaming systems in which the communication network includes a WAN are substantially identical to gaming systems in which the communication network includes a LAN, though the quantity of EGMs (or personal gaming devices) in such gaming systems may vary relative to one another.

In further embodiments in which the gaming system includes: (a) an EGM (or personal gaming device) configured to communicate with a central server, central controller, or remote host through a data network; and/or (b) a plurality of EGMs (or personal gaming devices) configured to communicate with one another through a communication network, the communication network may include an internet (such as the Internet) or an intranet. In certain such embodiments, an Internet browser of the EGM (or personal gaming device) is usable to access an Internet game page from any location where an Internet connection is available. In one such embodiment, after the EGM (or personal gaming device) accesses the Internet game page, the central server, central controller, or remote host identifies a player before enabling that player to place any wagers on any plays of any wagering games. In one example, the central server, central controller, or remote host identifies the player by requiring a player account of the player to be logged into via an input of a unique player name and password combination assigned to the player. The central server, central controller, or remote host may, however, identify the player in any other suitable manner, such as by validating a player tracking identification number associated with the player; by reading a player tracking card or other smart card inserted into a card reader; by validating a unique player identification number associated with the player by the central server, central controller, or remote host; or by identifying the EGM (or personal gaming device), such as by identifying the MAC address or the IP address of the Internet facilitator. In various embodiments, once the central server, central controller, or remote host identifies the player, the central server, central controller, or remote host enables placement of one or more wagers on one or more plays of one or more primary or base games and/or one or more secondary or bonus games, and displays those plays via the Internet browser of the EGM (or personal gaming device). Examples of implementations of Internet-based gaming are further described in U.S. Patent No. 8,764,566, entitled “Internet Remote Game Server,” and U.S. Patent No. 8,147,334, entitled “Universal Game Server.”

The central server, central controller, or remote host and the EGM (or personal gaming device) are configured to connect to the data network or remote communications link in any suitable manner. In various embodiments, such a connection is accomplished via: a conventional phone line or other data transmission line, a digital subscriber line (DSL), a T-1 line, a coaxial cable, a fiber optic cable, a wireless or wired routing device, a mobile communications network connection (such as a cellular network or mobile Internet network), or any other suitable medium. The expansion in the quantity of computing devices and the quantity and speed of Internet connections in recent years increases opportunities for players to use a variety of EGMs (or personal gaming devices) to play games from an ever-increasing quantity of remote sites. Additionally, the enhanced bandwidth of digital wireless communications may render such technology suitable for some or all communications, particularly if such communications are encrypted. Higher data transmission speeds may be useful for enhancing the sophistication and response of the display and interaction with players.

As should be appreciated by one skilled in the art, aspects of the present disclosure have been illustrated and described herein in any of a number of patentable classes or context including any new and useful process, machine, manufacture, or composition of matter, or any new and useful improvement thereof. Accordingly, aspects of the present disclosure may be implemented entirely hardware, entirely software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the "C" programming language, Visual Basic, Fortran 2003, Perl, COBOL 2002, PHP, ABAP, dynamic programming languages such as Python, Ruby and Groovy, or other programming languages. The program code may execute entirely on the user’s computer, partly on the user’s computer, as a stand-alone software package, partly on the user’s computer and partly on a remote computer or entirely on the remote computer or server. In the latter scenario, the remote computer may be connected to the user’s computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure have been described herein with reference to flowchart illustrations and/or block diagrams of methods, apparatuses (systems) and computer program products according to embodiments of the disclosure. It should be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

The term “a” or “an” entity refers to one or more of that entity. As such, the terms “a” (or “an”), “one or more,” and “at least one” can be used interchangeably herein. It is also to be noted that the terms “comprising,” “including,” and “having” can be used interchangeably.

What is claimed is:

1. A system comprising:
a communication interface;
a processor coupled with the communication interface; and
a memory coupled with and readable by the processor and storing therein a set of instructions which, when executed by the processor, causes the processor to:
receive, from each of a plurality of gaming systems of a gaming venue, via the communication interface, game event information for a set of primary electronic games conducted on the plurality of gaming systems;
maintain a value in an electronic record indicating a rate of exchange to a local currency for the gaming venue; and
conduct a secondary electronic game based on the rate of exchange to the local currency for the gaming venue, wherein the value in the electronic record indicating the rate of exchange to the local currency for the gaming venue is adjusted in the secondary electronic game based on the received game event information for the set of primary electronic games.

2. The system of claim 1, wherein the received game event information from the set of primary electronic games indicates a win event in a primary electronic game in the set of primary electronic games and wherein conducting the secondary electronic game based on the rate of exchange to the local currency for the gaming venue comprises increasing the value in the electronic record indicating the rate of exchange to the local currency for the gaming venue.

3. The system of claim 2, wherein increasing the value in the electronic record indicating the rate of exchange to the local currency for the gaming venue comprises increasing the value in the electronic record indicating the rate of exchange to the local currency for the gaming venue linearly based on the win event.

4. The system of claim 1, wherein the received game event information from the set of primary electronic games indicates a cash out event in a primary electronic game in the set of primary electronic games and wherein conducting the secondary electronic game based on the rate of exchange to the local currency for the gaming venue comprises decreasing the value in the electronic record indicating the rate of exchange to the local currency for the gaming venue.

5. The system of claim 4, wherein decreasing the value in the electronic record indicating the rate of exchange to the local currency for the gaming venue comprises decreasing the value in the electronic record indicating the rate of exchange to the local currency for the gaming venue linearly based on the cashout event.

6. The system of claim 1, wherein maintaining the value in the electronic record indicating the rate of exchange to the local currency for the gaming venue comprises maintaining the value in the electronic record indicating the rate of exchange to the local currency for the gaming venue at or above a predetermined minimum value.

7. The system of claim 1, wherein maintaining the value in the electronic record indicating the rate of exchange to the local currency for the gaming venue comprises maintaining the value in the electronic record indicating the rate of exchange to the local currency for the gaming venue at or below a predetermined maximum value.

8. The system of claim 7, wherein maintaining the value in the electronic record indicating the rate of exchange to the local currency for the gaming venue at or below a predetermined maximum value comprises triggering a cash out event in the set of primary electronic games in response to the value in the electronic record indicating the rate of exchange to the local currency for the gaming venue being equal to the predetermined maximum value.

9. The system of claim 7, wherein maintaining the value in the electronic record indicating the rate of exchange to the local currency for the gaming venue at or below a predetermined maximum value comprises pausing the secondary electronic game in response to the value in the electronic record indicating the rate of exchange to the local currency for the gaming venue being equal to the predetermined maximum value.

10. A gaming system comprising:
a processor; and
a memory coupled with and readable by the processor and storing therein a set of instructions which, when executed by the processor, causes the processor to:
execute a primary electronic game with a player;
detect a win event in the primary electronic game, wherein the win event is associated with a payout amount in a local currency;
present to the player an option to participate in a secondary electronic game using the payout amount associated with the win event in the primary electronic game, wherein the secondary electronic game is conducted based on a current value of a variable exchange rate associated with the local currency; and
in response to receiving an input indicating acceptance of the option to participate in the secondary electronic game, incrementing a credit meter of the primary electronic game based on the payout amount in the local currency associated with the win event and the current value of the variable exchange rate associated with the local currency.

11. The gaming system of claim 10, wherein the current value of the variable exchange rate associated with the local currency is variable based on events occurring in electronic games being conducted on a plurality of gaming systems within a gaming venue.

12. The gaming system of claim 11, wherein the events occurring in the electronic games being conducted on the plurality of gaming systems within the gaming venue comprise win events and cashout events.

13. The gaming system of claim 11, wherein the instructions further cause the processor to:
monitor the current value of the variable exchange rate associated with the local currency; and
adjust the credit meter of the primary electronic game based on the current value of the variable exchange rate associated with the local currency.

14. The gaming system of claim 13, wherein the instructions further cause the processor to:
detect a cashout event in the secondary game; and
in response to the detected cashout event, provide to the player a credit in the local currency based on the credit meter of the primary electronic game and the current value of the variable exchange rate associated with the local currency.

15. The gaming system of claim 10, wherein the instructions further cause the processor to:
detect a cashout event in the secondary game;
present to the player an option to participate in a tertiary electronic game using a current amount of the credit meter, wherein the tertiary electronic game determines the variable exchange rate associated with the local currency; and
in response to receiving an input indicating acceptance of the option to participate in the tertiary electronic game, conducting the tertiary electronic game and determining a payout amount in the local currency based on the current amount of credit meter and the variable exchange rate associated with the local currency determined by the tertiary game.

16. A method for conducting electronic games in a gaming venue, the method comprising:
receiving, by a processor of a gaming venue host system, from each of a plurality of gaming systems of a gaming venue, game event information for a set of primary electronic games conducted on the plurality of gaming systems;
maintaining, by the processor of a gaming venue host system, a value in an electronic record indicating a rate of exchange to a local currency for the gaming venue; and
conducting, by the processor of a gaming venue host system, a secondary electronic game based on the rate of exchange to the local currency for the gaming venue, wherein the value in the electronic record indicating the rate of exchange to the local currency for the gaming venue is adjusted in the secondary electronic game based on the received game event information for the set of primary electronic games.

17. The method of claim 16, wherein the received game event information from the set of primary electronic games indicates a win event in a primary electronic game in the set of primary electronic games and wherein conducting the secondary electronic game based on the rate of exchange to the local currency for the gaming venue comprises increasing the value in the electronic record indicating the rate of exchange to the local currency for the gaming venue.

18. The method of claim 17, wherein increasing the value in the electronic record indicating the rate of exchange to the local currency for the gaming venue comprises increasing the value in the electronic record indicating the rate of exchange to the local currency for the gaming venue non-linearly based on the win event.

19. The method of claim 16, wherein the received game event information from the set of primary electronic games indicates a cash out event in a primary electronic game in the set of primary electronic games and wherein conducting the secondary electronic game based on the rate of exchange to the local currency for the gaming venue comprises decreasing the value in the electronic record indicating the rate of exchange to the local currency for the gaming venue.

20. The method of claim 16, wherein the secondary electronic game comprises a crash game and wherein the crash game causes the current exchange to the local currency for the gaming venue to decrease upon the occurrence of an event within the secondary electronic game.
